(19) United States
(12) Patent Application Publication
(10) Pub. No.: US 2009/0122725 A1
(43) Pub. Date: May 14, 2009

(54) ROBUST NETWORKS FOR NON-DISRUPTIVELY DISCONNECTING PERIPHERAL DEVICES

(75) Inventors: Keith A. Souders, Tampa, FL (US); Jamal Haque, Clearwater, FL (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/937,732

(22) Filed: Nov. 9, 2007

(51) Int. Cl. H04L 12/28

(52) U.S. Cl. 370/257

(57) ABSTRACT

A network and method for non-disruptively disconnecting communication devices are disclosed. The network includes a primary network unit including a first logical layer, and a plurality of secondary network units. Each secondary network unit of the plurality of secondary network units includes the first logical layer, a second logical layer, and a connector arranged at a junction of the first logical layer and the second logical layer. The network also includes a plurality of electrically conductive links, wherein an electrically conductive link of the plurality of electrically conductive links is connected to the first logical layer of a first network unit at a first end, and to the first logical layer of a second network unit at a second end.

### RELATED APPLICATIONS

The present application is related to commonly assigned and co-pending U.S. patent application Ser. No. 11/608,905 entitled “APPARATUS FOR NON-DISRUPTIVELY DISCONNECTING A PERIPHERAL DEVICE”, filed on Dec. 11, 2006, and U.S. patent application Ser. No. 11/935,127 (Attorney Docket No. H0016618-5808) entitled “APPARATUS AND METHOD FOR CONNECTIVITY IN NETWORKS CAPABLE OF NON-DISRUPTIVELY DISCONNECTING PERIPHERAL DEVICES”, filed on Nov. 5, 2007, each of which is incorporated herein by reference in its entirety.

### FIELD OF THE INVENTION

The invention is related to the telecommunications field, and more particularly, but not exclusively, to robust networks for non-disruptively disconnecting peripheral devices.

### BACKGROUND OF THE INVENTION

Plug and play (PnP) systems are used in virtually all personal computers and numerous computer-controlled machines as well. PnP systems, which are also known as hot-swapping systems, allow connections and disconnections of peripheral devices to a host system without manual installation of device drivers or a reboot of the host system.

A principle feature of a PnP system is its ability to automatically reconfigure a communication bus after the connection or disconnection of a peripheral device (“peripheral”). When a communication bus of the PnP system observes a change in the peripheral layout, the bus initiates a reset. A connect or disconnect of a peripheral is recognized by sensing the power to the peripheral or by a special circuit on the peripheral's connector. The reconfiguration process recognizes and reacquires all of the peripherals connected to the bus to ensure that each peripheral is properly loaded in the host system and is given access to the communication bus. The reconfiguration process must reconfigure all of the peripherals connected to the bus even if only one peripheral is connected or disconnected, in order to ensure that no peripherals are in conflict. The reconfiguration process recognizes any newly connected peripheral, and automatically retrieves and loads the drivers for that peripheral. Conversely, if a peripheral is disconnected, the reconfiguration process disables the peripheral's drivers within the system, and assigns that peripheral's time slot to another device. Some examples of commonly known PnP systems include Universal Serial Bus (USB), FireWire (IEEE 1394 protocol), and Peripheral Component Interconnect (PCI).

Existing communication buses typically include interfaces that allow devices to interact with the communication bus by converting the devices' complex commands and data into bit level data that can be transmitted over the bus. Many such interfaces are operated in accordance with protocols that are divided into layers. The layered design divides the functions of the protocol involved into a series of logical layers. Each layer requests services from the layer below and performs services for the layer above. Layering a protocol makes it easier to design and use. For example, the IEEE 1394 protocol is divided into a physical layer, a link layer, and a transaction layer.

The highest layer of the IEEE 1394 protocol is the transaction layer, which is responsible for reading, writing, and conveying other high level commands to and from each communicating device. The middle layer is the link layer, which handles data at a packet level. The lowest layer is the physical layer, which is responsible for actually transmitting and receiving data over the bus (including arbitration with the bus). Beyond the physical layer, the data is conveyed on the bus and is handled by another device. Consequently, the physical layer may be viewed as a junction between a peripheral and the other devices. Thus, the hardware connectors of a peripheral are located at the junction of the physical layer and the communication bus.

In existing PnP systems, such as for example, the PnP systems commonly used in spacecraft, the communication bus is often configured so that the peripherals are daisy-chained together. For example, FIG. 1 depicts a standard daisy chain configuration 100 for a network that can be operated in accordance with an IEEE 1394 protocol. Note that this technique places each peripheral one behind the other along a communication stream. Consequently, a message that is transmitted to one peripheral must be passed on by, or allowed to be passed through, that peripheral to the next peripheral in the chain. For example, in order for a message to be passed from the host 102 to the fifth peripheral 112 in the chain, the first four peripherals 104, 106, 108, 110 in the chain must forward the message before it can arrive at the fifth peripheral 112. Consequently, since any peripheral in the chain depends upon the viability of the peripherals upstream (because of the dependence on physical layer repeater functions), if one peripheral is incapable of forwarding data, then all of the peripherals downstream from that peripheral will lose communication with the host. This problem is illustrated by the disconnection of the third peripheral 108 in the chain shown, which disrupts communications to the downstream peripherals (e.g., 110, 112, etc.). Thus, a significant problem with the existing daisy chain systems and techniques is that if a peripheral is disconnected from the communication bus, the bus has to be reconfigured in order to remove the disconnected peripheral from the chain.

FIG. 2 depicts a standard star or point-to-point configuration 200 for a network that can also be operated in accordance with an IEEE 1394 protocol. Note that the primary advantage of this point-to-point configuration over the standard daisy chain configuration is that in the point-to-point configuration, a dedicated node at a “central unit” is connected to individual “remote unit” nodes. For example, in the point-to-point configuration 200 shown, node 203a of unit 204 in the “central unit” 202 is connected to node 205 of “remote unit” 208, and node 203b of unit 204 is connected to node 207 of “remote unit” 210. Thus, since the point-to-point configuration does not depend on physical layer pass-through, if a “remote unit” node (e.g., node 209 of “remote unit” 212) is disconnected from its dedicated node (e.g., node 211 of unit 206) in the “central unit” 202, communications are not disrupted between the other “remote unit” nodes and their respective dedicated nodes in the “central unit”. Admittedly, the standard point-to-point configuration is more robust than the standard daisy chain configuration, but the point-to-point configuration requires the use of more hardware and real estate at the “central unit” than the daisy chain configuration. In other words, the standard point-to-point technique provides more robust performance with respect to broken links than the standard daisy chain technique, but this increase in robustness is provided at the expense of increased power, weight, size and cost.

In the above-described, related U.S. patent application Ser. No. 11/608,905 (“the '905 Application”), a novel method and apparatus is disclosed that solves the above-described problems, by allowing disconnection of a peripheral from a communication bus without causing disruption to other peripherals on the bus. This non-disruptive disconnection is accomplished by physically disconnecting the peripheral from the communication bus without causing a reconfiguration of the bus. More precisely, the non-disruptive disconnection is accomplished by placing the physical connector for the peripheral between the interfaces for the physical layer and link layer of the protocol involved. Before a peripheral is disconnected, the link layer is disabled. However, the physical layer remains enabled while the peripheral is being disconnected, because the arrangement of the peripheral's connector at the interface between the physical layer and the link layer enables the peripheral to be removed without removing the physical layer. Thus, based on the novel techniques disclosed in the '905 Application, the communication bus does not have to be reconfigured after a peripheral is disconnected, because the bus can still communicate with all of the same physical layers it communicated with before the peripheral was disconnected.

Notwithstanding the numerous advantages of the novel techniques disclosed in the '905 Application, there is no robust or semi-robust network configuration that currently exists that can implement the techniques disclosed in the '905 Application. For example, with the implementation of new high speed interfaces such as those included in the IEEE 1394 or 1394(a) or (b) protocols targeted for space and military applications, such requirements as performance, power, weight and size have to justify the choice. Considering the example of the IEEE 1394 protocol, existing network configuration topologies can provide reduced power, weight and size but with continued susceptibility to broken links, or they can provide robust connectivity for broken links at the expense of reduced power, weight and size. Thus, in order to take full advantage of the novel configurations disclosed in the '905 Application, suitable network configurations have to be provided. In other words, there are no existing network configurations that can be implemented using the separated physical layer and link layer interfaces disclosed in the '905 Application. Consequently, the existing network configurations are unable to capitalize on all of the potential advantages and benefits of the novel techniques disclosed in the '905 Application, such as increased robustness with respect to broken links, and decreased power consumption, size, weight and cost. Therefore, a pressing need exists for new network configurations capable of non-disruptively disconnecting peripheral devices, such as for example, networks capable of implementing the non-disruptive disconnection techniques disclosed in the '905 Application, which can provide a robust topology and also minimize power consumption, size, weight and costs.

### SUMMARY OF THE INVENTION

In a first example embodiment, a network for non-disruptively disconnecting communication devices is provided. The network includes a primary network unit including a first logical layer, and a plurality of secondary network units. Each secondary network unit of the plurality of secondary network units includes the first logical layer, a second logical layer, and a connector arranged at a junction of the first logical layer and the second logical layer. The network also includes a plurality of electrically conductive links, wherein an electrically conductive link of the plurality of electrically conductive links is connected to the first logical layer of a first network unit at a first end, and to the first logical layer of a second network unit at a second end.

In a second example embodiment, a network for non-disruptively disconnecting peripheral devices is provided. The network includes a communication bus including a physical layer for interacting with a peripheral device, a central device including the physical layer, and a plurality of remote devices. Each remote device of the plurality of remote devices includes the physical layer, a link layer, and a connector arranged at a junction of the physical layer and the link layer. The network also includes a plurality of cables, wherein a cable of the plurality of cables is connected to the physical layer of the central device at a first end, and to the physical layer of a remote device at a second end.

In a third example embodiment, a method for non-disruptively disconnecting communication devices is provided. The method includes the steps of including a first logical layer in a primary network unit, including the first logical layer, a second logical layer, and a connector arranged at a junction of the first logical layer and the second logical layer in each secondary network unit of a plurality of secondary network units, and connecting an electrically conductive link of a plurality of electrically conductive links to the first logical layer of a first network unit at a first end, and the first logical layer of a second network unit at a second end.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a standard daisy chain configuration for a network that can be operated in accordance with an IEEE 1394 protocol;

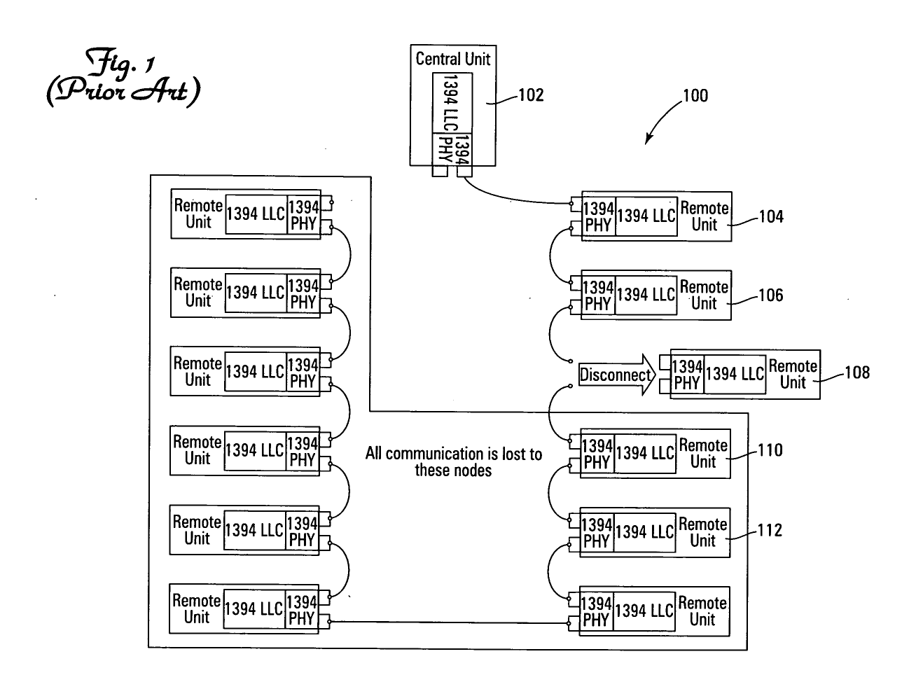

FIG. 2 a standard star or point-to-point configuration for a network that can also be operated in accordance with an IEEE 1394 protocol;

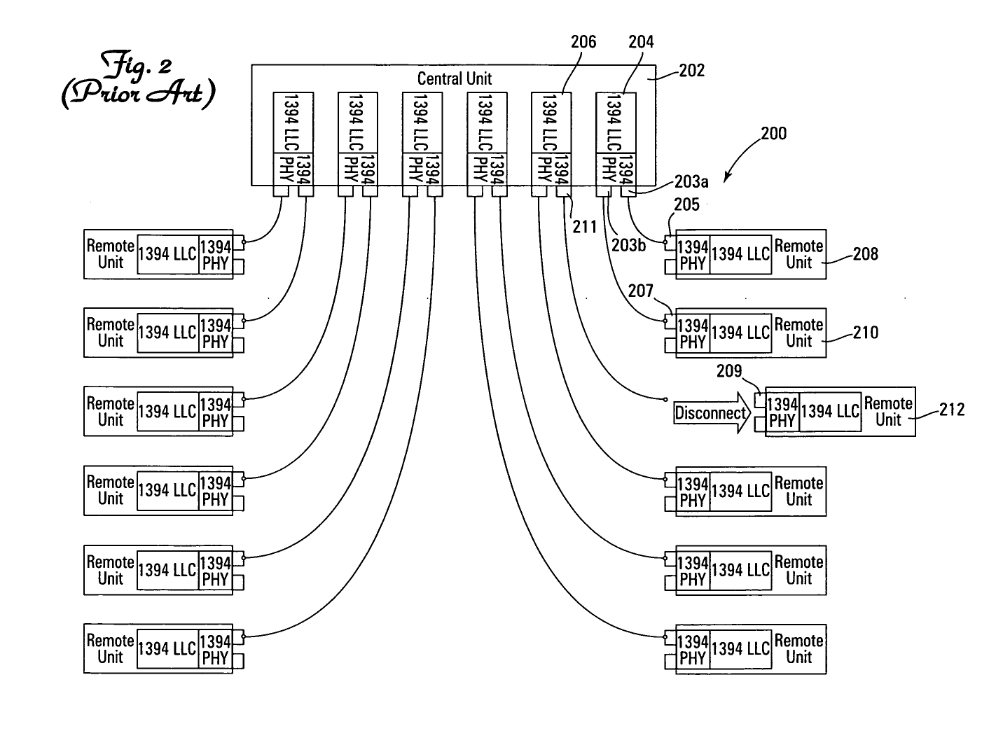

FIG. 3 is a block diagram depicting a robust network, which can be used to implement one or more example embodiments of the present invention; and

FIG. 4 is a block diagram depicting a hybrid or semi-robust network, which can be used to implement one or more example embodiments of the present invention.

### DETAILED DESCRIPTION OF PREFERRED EMBODIMENT(S)

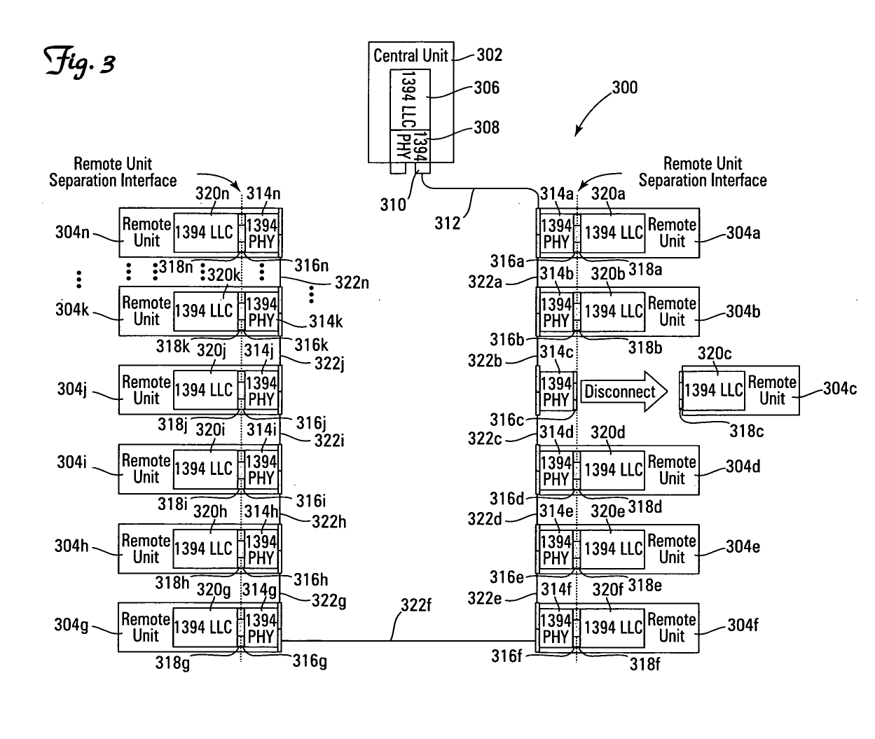

With reference again to the figures, FIG. 3 is a block diagram depicting a robust network 300, which can be used to implement one or more example embodiments of the present invention. For illustrative purposes in the example embodiment shown, the network 300 may represent one or more configurations for networks being operated in accordance with the IEEE 1394b protocol.

Note that, for the one or more example embodiments depicted in FIG. 3, only two-node physical layer interfaces are shown. In other words, each physical layer segment shown in this illustrative example includes two matching and biasing networks and two cable connections. However, the present invention is not intended to be so limited and can include any suitable number of nodes for the physical layer interfaces involved. For example, the present invention might include physical layer segments with three matching and biasing networks and three cable connections each. As such, if more than three nodes per physical layer segment are to be used, the last device in the chain could require only a single node. If that last device were to be disconnected robustly, that function could be accomplished with a single node, robust interface.

Also note that, for the one or more example embodiments depicted in FIG. 3, thirteen devices (one pseudo-master or “host” device and twelve remote devices) are shown. However, the present invention is not intended to be so limited and can include any suitable number of devices for the network configuration involved. Albeit, as a practical matter, the maximum number of devices that can be used is typically dictated by the bus specifications involved. For example, in accordance with the IEEE 1394 bus specifications, a maximum of 63 devices can be connected to one bus. In any event, a typical network configuration can include a substantial number of devices, and the present invention can be implemented using some or all of the devices involved.

Note further that, for the one or more example embodiments depicted in FIG. 3, no physical layer power source is explicitly shown. However, the present invention is not intended to be so limited and can include any suitable number of physical layer power sources for the network configuration involved. For example, depending on the number of devices on the bus involved, one or more physical layer power source(s) may be provided. The one or more physical layer power source(s) provided can be internal to the physical layer, external to the physical layer, or one or more combinations thereof. Proper implementation can be assured by suitable routing and connection of the cabling involved.

Essentially, the present invention provides novel network configurations that can accommodate the novel technique of non-disruptively disconnecting peripheral devices in networks including robust physical layer/link layer connections, as well as hybrid or semi-robust networks including both standard and robust connections. By building such networks including peripheral devices with interfaces separated at the boundary between the physical layer and link layer, physical layer repeater functionality remains intact if a peripheral device is disconnected, has failed, or has been shut down. The integrity and robustness of the involved system remains intact and unchanged. The primary advantages of implementations of the present invention are networks realizing lower costs, lower power consumption, smaller sizes, and more robust topologies.

For some embodiments, the present invention may be used to implement one or more configurations for types of networks or applications other than those operated in accordance with an IEEE 1394 protocol, such as for example, Ethernet networks, USB interfaces, and the like. Essentially, the present invention may be used in any suitable type of network, application or system where more robust performance with respect to broken links is desired.

Specifically, the exemplary network 300 shown in FIG. 3 includes a central unit 302 (e.g., pseudo-master device, host device, etc.) and a plurality of remote units 304a through 304n (where the “nth” device/unit represents the last device/unit of the plurality of devices/units involved). The central unit 302 includes a link layer segment 306, a physical layer segment 308, and at least one node 310 for the physical layer segment 308. Although not explicitly shown, for some example embodiments, the physical layer segment 308 can include a matching and biasing network for each node used in the central unit 302.

For one or more example embodiments, each remote unit of the plurality of remote units 304a-304n includes a respective physical layer segment 314a-314n, a connector 316a-316n for each physical layer segment 314a-314n, a link layer segment 320a-320n, and a connector 318a-318n for each link layer segment 320a-320n. The respective connector pairs 316a-316n, 318a-318n (e.g., 316a, 318a) are matched connectors that can be plugged into one another. For some embodiments, each physical layer segment 308 and 314a-314n includes a first matching and biasing network (not shown) and a second matching and biasing network (not shown). An active cable segment 312 and 322a-322n is connected to a matching and biasing network of the physical layer segment of the central unit or a remote unit on one end, and to the first matching and biasing network of the physical layer segment in the next device on the second end. For example, the active cable segment 312 is connected to the matching and biasing network associated with the node 310 of the central unit 302 on one end, and the first matching and biasing network of the physical layer segment 314a of the remote unit 304a on the second end. Also, for example, the active cable segment 322a is connected to the second matching and biasing network of physical layer segment 314a of remote unit 304a on one end, and to the first matching and biasing network of physical layer segment 314b of remote unit 304b on the second end. As shown, for one or more example embodiments, each physical layer segment 314a-314n, link layer segment 320a-320n, and the associated matching connectors 316a-316n, 318a-318n compose a robust connection for an IEEE 1394b network configuration, and the robust connection can be used to non-disruptively disconnect a peripheral device from the 1394b network involved.

For example, in the illustrative embodiments shown, note that the remote unit 304c (e.g., a peripheral device) has been disconnected from the chain. However, in accordance with the present invention, the remote unit 304c has been disconnected at the interface between the physical layer segment 314c and the link layer segment 320c. Consequently, the integrity of the physical layer's repeater function in the network 300 has been maintained, and any such break or disconnection of such a remote unit does not disable communications to any other remote unit in the network involved. Thus, the topology of network 300 is robust and relatively simple to implement.

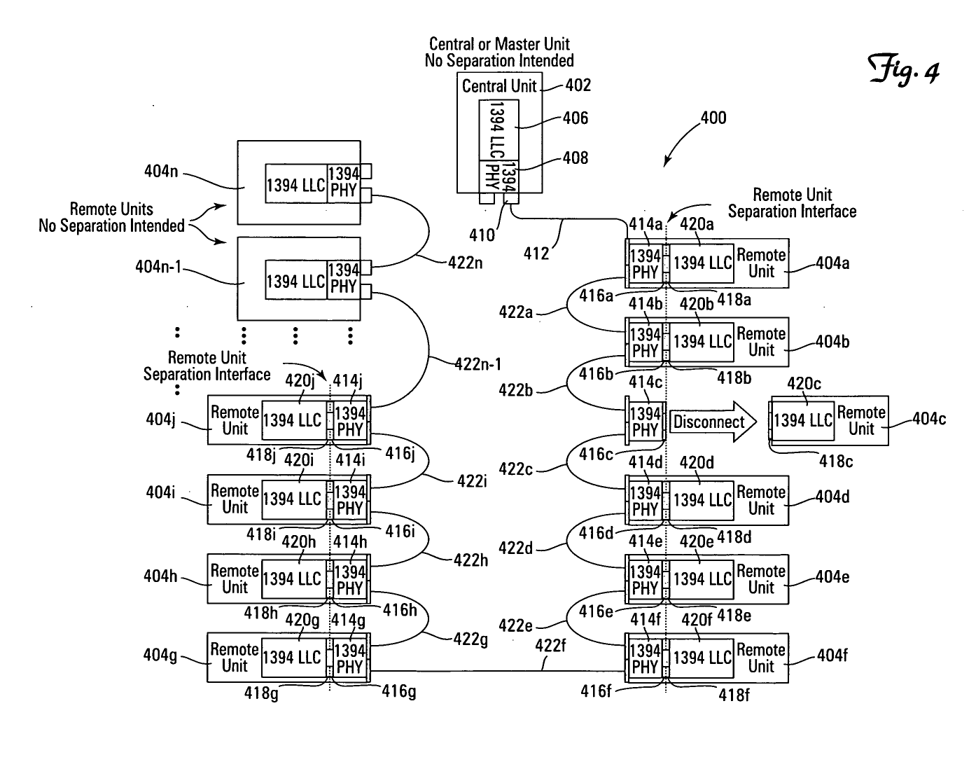

FIG. 4 is a block diagram depicting a hybrid or semi-robust network 400, which can be used to implement one or more example embodiments of the present invention. For illustrative purposes in the example embodiment shown, network 400 may represent one or more configurations for networks being operated in accordance with the IEEE 1394b protocol.

Note that, for the one or more example embodiments depicted in FIG. 4, only two-node physical layer interfaces are shown. Thus, each physical layer segment shown in this illustrative example includes two matching and biasing networks and two cable connections. However, the present invention is not intended to be so limited and can include any suitable number of nodes for the physical layer interfaces involved. For example, the present invention might include physical layer segments with three matching and biasing networks and three cable connections each. As such, if more than three nodes per physical layer segment are to be used, the last device in the robust part of the chain could require only a single node. If that last device were to be disconnected robustly, that function could be accomplished with a single node, robust interface.

Also note that, for the one or more example embodiments depicted in FIG. 4, thirteen devices (one pseudo-master or “host” device and twelve remote devices) are shown. However, the present invention is not intended to be so limited and can include any suitable number of devices for the network configuration involved. Albeit, as a practical matter, the maximum number of devices that can be used is typically dictated by the bus specifications involved. For example, in accordance with the IEEE 1394 bus specifications, a maximum of 63 devices can be connected to one bus. In any event, a typical network configuration can include a substantial number of devices, and the present invention can be implemented using some or all of the devices involved.

Note further that, for the one or more example embodiments depicted in FIG. 4, no physical layer power source is explicitly shown. However, the present invention is not intended to be so limited and can include any suitable number of physical layer power sources for the network configuration involved. For example, depending on the number of devices on the bus involved, one or more physical layer power source(s) may be provided. The one or more physical layer power source(s) provided can be internal to the physical layer, external to the physical layer, or one or more combinations thereof. Proper implementation can be assured by suitable routing and connection of the cabling involved.

Essentially, for the example embodiments shown in FIG. 4, the present invention provides novel network configurations that can accommodate the technique of non-disruptively disconnecting peripheral devices in networks including hybrid or semi-robust networks with both standard and robust connections. As shown, for example, standard configuration remote units can be used where their separation from the network is unlikely to occur (e.g., a central unit, remote units used for specific applications, etc.). As a design constraint only, and not intended as a limitation on the scope of the present invention, in order to assure proper non-disruptive functionality, the standard configuration remote units should be connected at the end of the “chain” of units involved.

For some embodiments, the present invention may be used to implement one or more configurations for types of networks or applications other than those operated in accordance with an IEEE 1394 protocol, such as for example, Ethernet networks, USB interfaces, and the like. Essentially, the present invention may be used in any suitable type of network or application where more robust performance with respect to broken links is desired.

Specifically, the exemplary hybrid or semi-robust network 400 shown in FIG. 4 includes a central unit 402 (e.g., pseudo-master device, host device, etc.) and a plurality of remote units 404a through 404n (where the “nth” device/unit represents the last device/unit of the plurality of devices/units involved). For the example embodiments shown, the remote units 404n-1 and 404n are configured as standard (not robust) remote units. The central unit 402 includes a link layer segment 406, a physical layer segment 408, and at least one node 410 for the physical layer segment 408. Although not explicitly shown, for some example embodiments, the physical layer segment 408 can include a matching and biasing network for each node used in the central unit 402.

For one or more example embodiments, each remote unit of the plurality of robust remote units 404a-404j includes a respective physical layer segment 414a-414j, a connector 416a-416j for each physical layer segment 414a-414j, a link layer segment 420a-420j, and a connector 418a-418j for each link layer segment 420a-420j. The respective connector pairs 416a-416j, 418a-418j (e.g., 416a, 418a) are matched connectors that can be plugged into one another. For some embodiments, each physical layer segment 408 and 414a-414n includes a first matching and biasing network (not shown) and a second matching and biasing network (not shown). A cable segment 412 and 422a-422n is connected to a matching and biasing network of the physical layer segment of the central unit or a remote unit on one end, and to the first matching and biasing network of the physical layer segment in the next device on the second end. For example, the cable segment 412 is connected to the matching and biasing network associated with the node 410 of the central unit 402 on one end, and the first matching and biasing network of the physical layer segment 414a of the remote unit 404a on the second end. Also, for example, the cable segment 422a is connected to the second matching and biasing network of physical layer segment 414a of remote unit 404a on one end, and to the first matching and biasing network of physical layer segment 414b of remote unit 404b on the second end. As shown, for one or more example embodiments, each physical layer segment 414a-414j, link layer segment 420a-420j, and the associated matching connectors 416a-416j, 418a-418j compose a robust connection for an IEEE 1394b network configuration, and the robust connection can be used to non-disruptively disconnect a peripheral device from the 1394b network involved. However, as also shown, remote units 404n-1 and 404n are standard configuration devices, and thus remote unit 404n-1 cannot be disconnected from network 400 without disrupting communications to remote unit 404n.

For example, note that in the illustrative embodiments shown, similar to network 300 in FIG. 3, the remote unit 404c (e.g., a peripheral device) has been disconnected from the chain. However, in accordance with the present invention, the remote unit 404c has been disconnected at the interface between the physical layer segment 414c and the link layer segment 420c. Consequently, with respect to remote units 404a-404j, the integrity of the physical layer's repeater function in the network 400 has been maintained, and any such break or disconnection of such a robust remote unit does not disable communications to any other robust remote unit in the network involved. Only disconnection of the non-robust, standard configuration remote units (e.g., 404n-1 and 404n) will disable communications to the remote units further down the chain.

The following table summarizes the primary differences/advantages of robust networks configured in accordance with the present invention, and networks configured with standard topologies.

TABLE #1
Configuration Comparison Table

Honeywell

| | | Disconnect | | Size, Weight, | |
|---|---|---|---|---|---|
| Topology | Communication Link | Point | Robust | Power Burden | Comments |
| Star | Direct Point-to-Point | Cable/PHY | Very Robust | Very Large Size | This topology is very robust with a |
| | | | | Very High Weight | remote unit disconnect. The central unit |
| | | | | Very High Power | is burdened with substantial hardware |
| | | | | | penalties which increases devices and |
| | | | | | circuitry as well as the associated power |
| | | | | | and heat from added devices. |
| Daisy Chain | Point-to-Point thru | Cable/PHY | Not robust | Small Size | This topology is not robust with a remote |
| | Repeaters | | | Low Weight | unit disconnect. This configuration |
| | | | | Low Power | requires the least amount of hardware |
| | | | | | and circuitry. |
| Robust | Point-to-Point thru | PHY/LLC | Very Robust | Small Size | This topology is very robust with a |
| Network | Repeaters | | | Low Weight | remote unit disconnect. By placing the |
| | | | | Low Power | separation point for disconnecting |
| | | | | | remote units at the PHY/LLC interface |
| | | | | | the repeater function remains intact. |
| | | | | | This topology uses the same minimal |
| | | | | | hardware and circuitry as the standard |
| | | | | | Daisy Chain configuration |

It is important to note that while the present invention has been described in the context of a fully functioning robust or semi-robust network for non-disruptively disconnecting peripheral devices, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular robust or semi-robust network for non-disruptively disconnecting peripheral devices.

The description of the present invention has been presented for purposes of illustration and description, and is not intended to be exhaustive or limited to the invention in the form disclosed. Many modifications and variations will be apparent to those of ordinary skill in the art. These embodiments were chosen and described in order to best explain the principles of the invention, the practical application, and to enable others of ordinary skill in the art to understand the invention for various embodiments with various modifications as are suited to the particular use contemplated.

What is claimed is:

1. A network for non-disruptively disconnecting communication devices, comprising:
a primary network unit including a first logical layer;
a plurality of secondary network units, each secondary network unit of the plurality of secondary network units including the first logical layer, a second logical layer, and a connector arranged at a junction of the first logical layer and the second logical layer; and
a plurality of electrically conductive links, an electrically conductive link of the plurality of electrically conductive links connected to the first logical layer of a first network unit at a first end, and to the first logical layer of a second network unit at a second end.

2. The network of claim 1, wherein the primary network unit comprises at least one of a central unit, pseudo-master unit, and host unit.

3. The network of claim 1, wherein the plurality of secondary network units comprises a plurality of remote units, peripheral units or peripheral devices.

4. The network of claim 1, wherein the first logical layer comprises a physical layer.

5. The network of claim 1, wherein the second logical layer comprises a link layer.

6. The network of claim 1, wherein the network comprises a plurality of communication units arranged in a star or daisy chain configuration.

7. The network of claim 1, further comprising:
at least one standard network unit including the first logical layer, the second logical layer, an electrically conductive link of the plurality of electrically conductive links connected to the first logical layer of a second network unit at a first end, and to the first logical layer of the at least one standard network unit at a second end, and excluding the connector at the junction of the first logical layer and the second logical layer.

8. The network of claim 1, further comprising:
at least one standard network unit including the first logical layer, the second logical layer, an electrically conductive link of the plurality of electrically conductive links connected at a first end to the first logical layer of a second network unit located at an end of a chain of network units, and to the first logical layer of the at least one standard network unit at a second end, and excluding the connector at the junction of the first logical layer and the second logical layer.

9. The network of claim 1, wherein the plurality of electrically conductive links comprises a plurality of active cables.

10. The network of claim 1, wherein the network comprises a network configured in accordance with an IEEE 1394 protocol.

11. A network for non-disruptively disconnecting peripheral devices, comprising:
a communication bus including a physical layer for interacting with a peripheral device;
a central device including the physical layer;
a plurality of remote devices, each remote device of the plurality of remote devices including the physical layer, a link layer, and a connector arranged at a junction of the physical layer and the link layer; and
a plurality of cables, a cable of the plurality of cables connected to the physical layer of the central device at a first end, and to the physical layer of a remote device at a second end.

12. The network of claim 11, further comprising:
at least one remote device including the physical layer, the link layer, and excluding the connector at the junction of the physical layer and the link layer; and
a cable of the plurality of cables connected to the physical layer of the at least one remote device at a first end, and to the physical layer of a remote device of the plurality of remote devices at a second end.

13. The network of claim 11, further comprising:
at least one remote device including the physical layer, the link layer, and excluding the connector at the junction of the physical layer and the link layer; and
a cable of the plurality of cables connected to the physical layer of the at least one remote device at a first end, and to the physical layer of a remote device at an end of a chain of the plurality of remote devices at a second end.

14. The network of claim 12, wherein the at least one remote device comprises a standard configuration peripheral device.

15. The network of claim 11, wherein the network comprises a network configured in accordance with an IEEE 1394 protocol.

16. A method for non-disruptively disconnecting communication devices, comprising the steps of:
including a first logical layer in a primary network unit;
including the first logical layer, a second logical layer, and a connector arranged at a junction of the first logical layer and the second logical layer in each secondary network unit of a plurality of secondary network units; and
connecting an electrically conductive link of a plurality of electrically conductive links to the first logical layer of a first network unit at a first end, and the first logical layer of a second network unit at a second end.

17. The method of claim 16, further comprising the steps of:
connecting at least one standard network unit including the first logical layer, the second logical layer, and an electrically conductive link of the plurality of electrically conductive links to the first logical layer of a second network unit at a first end;
connecting the electrically conductive link to the first logical layer of the at least one standard network unit at a second end; and
excluding the connector at the junction of the first logical layer and the second logical layer of the at least one standard network unit.

18. The method of claim 16, wherein the first logical layer comprises a physical layer, and the second logical layer comprises a link layer.

19. The method of claim 16, wherein the primary network unit comprises a central unit, and the plurality of secondary network units comprises a plurality of remote or peripheral devices.

20. The method of claim 16, wherein the steps are performed in a network configured in accordance with an IEEE 1394 protocol.
